(19) United States
(12) Patent Application Publication
(10) Pub. No.: US 2008/0073894 A1
(43) Pub. Date: Mar. 27, 2008

(54) Object holding system for use with vehicle seat belts

(76) Inventor: Judy L. Phillips, Pompano Beach, FL (US)

Correspondence Address: Donald W. Meeker;Patent Agent, 924 East Ocean Front #E, Newport Beach, CA, 92661, US

(21) Appl. No.: 11/502,557

(22) Filed: Aug. 11, 2006

(51) Int. Cl. B60R 22/00; A62B 35/00

(52) U.S. Cl. 280/801.1; 297/468

(57) ABSTRACT

A system to secure an object, such as a vase of flowers, on the passenger seat of a vehicle using a pair of clamps to hold a shoulder seat belt behind an object on the seat and the lap belt in front of an object on the seat (or visa versa) and clamp the lap seat belt and shoulder seat belt together with a clamp on each side of the object. The system further comprises high friction rubber or synthetic anti-slip pad placed between the object and the seat to prevent the object from slipping on the seat.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to object securing devices and particularly to a system to secure an object, such as a vase of flowers, on the passenger seat of a vehicle using a pair of clamps to hold a shoulder seat belt behind an object on the seat and the lap belt in front of an object on the seat (or visa versa) and clamp the lap seat belt and shoulder seat belt together with a clamp on each side of the object and a high friction rubber or synthetic anti-slip pad placed between the object and the seat to prevent the object from slipping on the seat.

2. Description of Related Art Including Information Disclosed Under 37 CFR 1.97 and 1.98

One of the problems frequently encountered in transporting objects, such as the transporting of cut and live flowers and plants and other articles in vases, pots, baskets, and receptacles holding same, is that of inadequate immobilization of the object in the vehicle. The container or object must be securely held in an upright position during transport to the final destination and kept from tilting, tipping over or breaking. A means for holding objects stationary on a vehicle seat should be able to be stored out of sight in the vehicle for use as needed without occupying a lot of storage space. Prior art devices are generally too large to store in a glove compartment and generally do not guarantee that an object will not fly off the seat in the event of a normal stop.

Prior art U.S. Patent Application #20050045496, published March 3, 2005 by Jenkins, concerns an apparatus and process for securing an object to the seat of an automobile, which comprises a box or carton for storing floral arrangements or other objects on an automobile seat. The box has openings which allow it and the object to be secured to the automobile seat by the seat belt. The box may have an automatic bottom which allows it to be stored flat and quickly erected, and may have an insert which has a slit and circular cutout and further secures the object. Instead of a box or carton, the invention may be applied by using only one or two sidewalls with openings and a bottom.

Prior art U.S. Pat. No. 6,880,703, issued Apr. 19, 2005 to Pena, provides a floral transport apparatus to facilitate the transportation and delivery of floral arrangements. The floral transport apparatus includes a hard plastic container housing a support carriage having a set of longitudinal elastic bands and a set of lateral elastic bands stretched tightly over a box frame to form an upper and lower mesh. The floral arrangement is held securely in the gaps between the tensioned bands of the upper and lower mesh to prevent lateral displacement which would otherwise result in tipping of the floral arrangement. The floral transport apparatus provides a means for carrying many floral arrangements of various sizes simultaneously. Moreover, the floral transport apparatus is easily portable and manageable by a single delivery person and can be washed to keep the apparatus attractive in view of floral customers and potential floral customers. An embodiment of the floral transport apparatus has a seat belt clip for securing the container to an automobile seat.

Prior art U.S. Pat. No. 6,796,469, issued Sep. 28, 2004 to Lofaro, shows a carrier device for the simple and secure transportation of objects, in particular flower containers, in a vehicle. As disclosed, the carrier device comprises a plurality of panels which when folded in a specific manner, form a device for securing an object. In addition, the device comprises notches for securing itself using a conventional seatbelt of a vehicle. Consequently, the device prevents the object from moving by holding the top of the object and surrounding the sides of the object. The device itself is then held stationary by placing a conventional seatbelt around the device, positioning the seatbelt in notches located in pre-determined location on the device. The design of the carrier device allows for the object to be some distance from the back of the seat and, as a result, prevent damage to the object.

Prior art U.S. Pat. No. 6,561,353, issued May 13, 2003 to Levieux, discloses an apparatus and method for securing a vase upon a car seat. The apparatus and method include elements and steps of providing a vase holder, the vase holder, having a ceiling panel, including a forward end, a rearward end, a right end, a left end, and a vase receiving aperture, the vase holder further having a front wall panel hingedly attached to the forward end of ceiling panel, a rear wall panel hingedly attached to a rearward end of the ceiling panel, a floor panel hingedly attached to a lower end of the front wall panel, a car seat engaging panel hingedly attached to a rearward end of the rear wall panel, and a tab and slot attachment for connecting the rearward end of the floor panel to the lower end of the rear wall panel; downwardly pivoting the front and rear wall panels; rearwardly pivoting the floor panel; attaching the floor panel to the lower end of the rear panel; inserting the car seat engaging panel into a cleft within the car seat; and, inserting the vase into the vase receiving aperture.

Prior art U.S. Pat. No. 2,822,968, issued Feb. 11, 1958 to Jackson, relates a flower arrangement carrier which comprises a length of textile material having an upper portion which covers and is secured to a seat back, an intermediate portion which covers the seat and a front portion that covers the front of the seat cushion. The upper and front portions of the carrier are provided with pockets and the intermediate seat portion is provided with a carrying tray for flower arrangements.

Two prior art U.S. Pat. No. 5,687,893 issued Nov. 18, 1997 and U.S. Design Pat. No. D415,730 issued Oct. 26, 1999, both to Jacobsmeyer, illustrate a package restraint for use in automotive vehicles. The restraint is placed in a seat normally occupied by an individual and is held in place by the seat belt worn by an occupant. The restraint has a rear piece which fits against the upright portion of a passenger seat and which is held in place by the seat belt. A bottom section of the restraint provides a seat for the package or article to rest upon. The length of this bottom section may be adjustable to accommodate different size packages. A front section of the restraint is also an upright piece. The front and rear pieces have openings for a belt to fit through the pieces and about the package to secure the restraint and package together. The restraint is made of a lightweight, fabric covered material for ease of use and to protect the package and seat in which the restraint is used. The belt is of a non-slip material so as not to fall off the package once secured thereto. The restraint protects the package and its contents from damage which might otherwise result from the rapid acceleration, sharp turns, or abrupt stoppages which may occur when the vehicle is moving.

Prior art U.S. Pat. No. 5,060,798, issued Oct. 29, 1991 to Braastad, describes a paperboard or cardboard blank for flower vases and the like, which has quandrantally located tabs die cut therein and inwardly located score or weakened fold lines. Outwardly spaced from the fold lines, that is, near the free ends of the tabs, are pairs of holes. With the exception of the holes in one tab, each hole in the other tabs has a slit and an entrance notch so as to facilitate the entrance of a portion of a ribbon. Whereas the tabs have holes formed therein, the blank has an additional first and second hole spaced from the tabs and also from each other, each having a slit and entrance notch to facilitate the insertion of a portion of a ribbon into the first and second holes. The blank has a square configuration, two corners thereof being provided with pairs of holes, each hole of each pair in the corners having slits and notches so as to also facilitate the insertion of ribbon portions so that the remaining end lengths of the ribbons can be wrapped around to anchor the ribbons after the ribbons, there being two, have been pulled taut to cause the tabs to tightly engage the sides of the vase and thus hold the vase in a stabilized vertical position for transportation.

Prior art U.S. Pat. No. 4,204,598, issued May 27, 1980 to Adams, claims a folder for holding a vase upright while it is being transported. The base of the vase is inserted into the device and held within the device during transportation.

What is needed is a means for holding a container or object securely held in an upright stationary position during transport in a vehicle to prevent it from tilting, tipping over, breaking or flying off the seat in the event of a normal stop, which means for holding objects stationary on a vehicle seat should be able to be stored out of sight in the vehicle for use as needed without occupying a lot of storage space store in a glove compartment.

### BRIEF SUMMARY OF THE INVENTION

An object of the present invention is to provide a pair of clamps for binding the shoulder seat belt and the lap seat belt together on each side of a container or object with the shoulder belt partially encircling one side of the object and the lap belt partially encircling another side of the object with the seat belt fastened and a high friction pad placed under the object between the object and a seat bottom of a vehicle to prevent the bottom of the object from sliding on the seat as a means for holding a container or object securely held in an upright stationary position during transport in a vehicle to prevent it from tilting, tipping over, breaking or flying off the seat in the event of a normal stop, which means for holding objects stationary on a vehicle seat can be stored out of sight in the glove compartment of the vehicle for use as needed without occupying a lot of storage space.

Another object of the present invention is to provide a means for holding a container or object securely in an upright stationary position during transport in a vehicle which may be compactly prepackaged in a kit containing clips or clamps, a high friction pad and instructions for use, which requires minimal retail space.

In brief, an object securing system that comprises a pair of clips or clamps for binding the shoulder seat belt and the lap seat belt together on each side of a container or object with the shoulder belt partially encircling one side of the object and the lap belt partially encircling another side of the object with the seat belt fastened. The object securing system also comprises a high friction pad placed under the object, between the object and a seat bottom of a vehicle, to prevent the bottom of the object from sliding on the seat. The object securing system holds a container or object securely in an upright stationary position during transport in a vehicle to prevent it from tilting, tipping over, breaking or flying off the seat in the event of a normal stop or turn. The clamps and high friction pad are compact and may be stored out of sight in the glove compartment of the vehicle for use as needed without occupying a lot of storage space.

The pair of clamps may be any type of binding clamps including but not limited to flat cable clamps, cable clamps, clips, binder clips, cable maintenance clips, merchandise clips. The high friction pad may be any type of material that is non-skid and preferably able to be rolled up or folded up for storage including material such as that used in rubberized self liner and bar liner for glasses. The flat high friction pad may be manufactured in varying shapes and sizes for other uses such as crock pots, soup pots, punchbowls, casserole dishes, baking pans, aquariums, or any other container which requires being secured in a vehicle seat.

The object securing system may be sold in a kit containing prepackaged flat cable clamps, a non-skid pad, and directions on how to use product. The prepackaged kit takes little room and can be sold beside flower arrangements in floral display cabinets at grocery stores or florist shops.

An advantage of the present invention is that it utilizes the existing seat belts of a vehicle for securely binding and locking the object in place on a vehicle seat bottom.

Another advantage of the present invention is that the high friction pad and binding clamps can be stored in the glove compartment of the vehicle.

One more advantage of the present invention is that the high friction pad assists in securing an object.

An additional advantage of the present invention is that a wide variety of clips or clamps may be used.

A further advantage of the present invention is that it is inexpensive.

Yet another advantage of the present invention is that is requires very little retail merchandising space.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the object securing system of the present invention with the high friction pad under a flower vase on a vehicle seat bottom and the pair of clips each binding the shoulder seat belt and the lap seat belt together on each side of the vase with the shoulder belt behind the vase and the lap belt in front of the vase and the buckle of the seat belt locked in place;

FIG. 2 is a perspective view of the high friction pad of the present invention and an elevational view of a pair of scissor type binding clamps of the present invention;

FIG. 3 is an elevational view in partial section of the pair of clamps of FIG. 2 with each of the clamps binding a portion of a shoulder belt and a lap belt therebetween;

FIG. 4 is an elevational view in partial section of a pair of enclosing binding clamps with the clamps each encircling and binding together a portion of the shoulder seat belt and the lap seat belt.

### DETAILED DESCRIPTION OF THE INVENTION

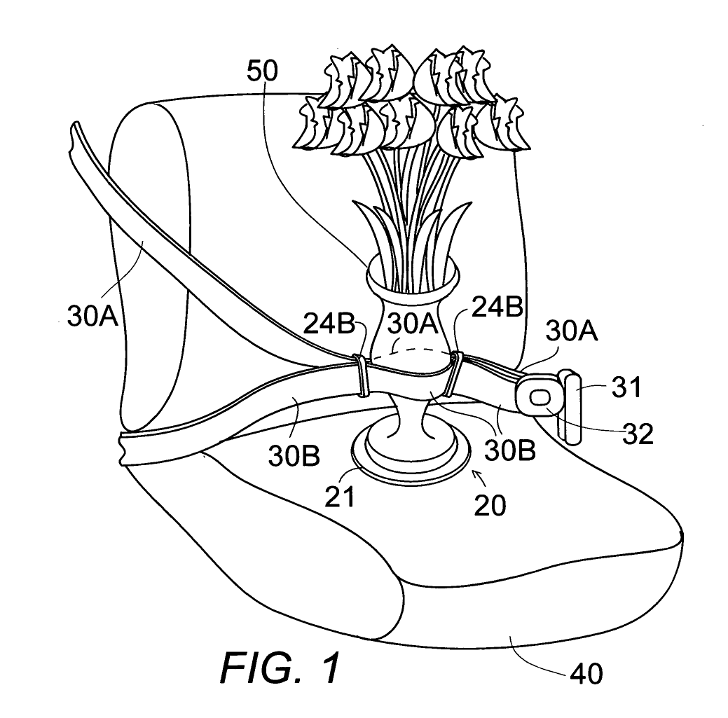

In FIGS. 1-4, an object securing system 20 for a vehicle comprises a pair of clamps 24A and 24B to bind a shoulder seat belt 30A and a lap seat belt 30B with a clamp 24A and 24B on each side of the object 50 with the seat belts 30A and 30B encircling the object 50 and a high friction pad 21 between the object 50 and the seat bottom 40 of a vehicle to prevent movement of the object 50 while transporting the object 50.

The object securing system 20 comprises a pair of clamps 24A and 24B for binding a shoulder seat belt 30A and a lap seat belt 30B of a vehicle around a body of an object 50 with the shoulder belt 30A on one side of the body of the object 50 and the lap belt 30B on an opposite side of the body of the object 50 to secure the object 50 from movement during transportation of the object 50 in the vehicle with the object resting on a seat bottom 40 of the vehicle. A first clamp 24A and 24B of the pair of clamps 24A and 24B binds the shoulder seat belt 30A and the lap seat belt 30B together adjacent to the body of the object 50 on a first side of the object 50, and a second clamp 24A and 24B of the pair of clamps 24A and 24B binds the shoulder seat belt 30A and the lap seat belt 30B together adjacent to the body of the object 50 on a second side of the object 50 opposite to the first side of the object 50 so that the shoulder belt 30A partially encircles the body of the object 50 on one side of the object 50 and the lap belt 30B partially encircles the body of the object 50 on an opposite side of the object 50 with the clamps 24A or 24B binding the belts 30A and 30B around the body of the object 50, as shown in FIG. 1.

The seat belts 30A and 30B are fastened to a seat belt lock 31 the seat belt buckle 32 to prevent movement of the object 50 during transportation of the object 50 in the vehicle. The clamps 24A and 24B are sized to fit into a glove compartment of the vehicle.

The pair of clamps 24A and 24B each comprise a pair of clamp legs 26 and 26A normally spaced apart in close proximity in parallel alignment, the pair of clamp legs 26 and 26A being separable to admit the shoulder-belt 30A and the lap belt 30B therebetween, as shown in FIGS. 1, 3 and 4. The pair of clamps 24A and 24B further comprise a means for locking the two clamp legs 26 and 26A together to exert a compressive force to bind together a portion of the two seat belts 30A and 30B contacting the clamp legs 26 and 26A. The means for locking the clamp legs 26 and 26A together comprises interlocking tabs 27 and 27A and a locking mechanism 28 and 28A.

The pair of clamps 24A and 24B may be any type of binding clamps including but not limited to flat cable clamps, cable clamps, clips, binder clips, cable maintenance clips, and merchandise clips.

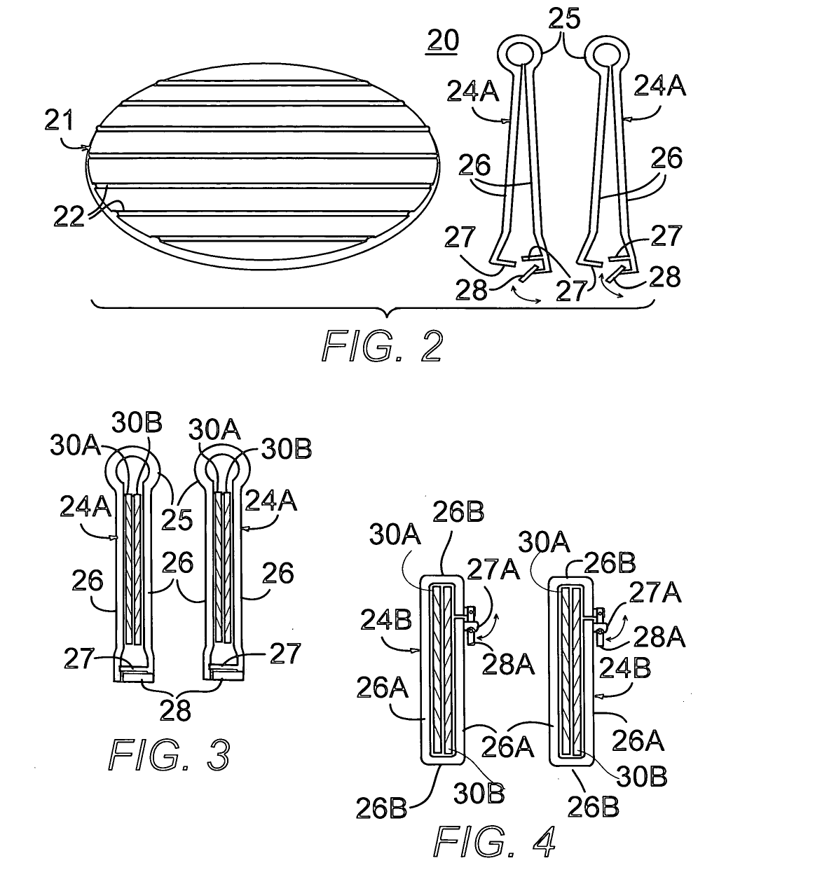

The object securing system 20 further comprises a high friction pad 21 placed under a bottom of the object 50 between the object 50 and the seat bottom 40 of the vehicle to prevent the bottom of the object 50 from sliding on the seat 40. The high friction pad 21 comprises a sheet of resilient flexible rubberized material which easily folds or rolls up for storage. The high friction pad 21 is sized to fit into the glove compartment of the vehicle with the pair of clamps 24A and 24B for storage of the high friction pad 21 and the pair of clamps 24A and 24B when not in use. The high friction pad 21 further comprises an uneven high friction surface 22, as shown in FIG. 2, to enhance the friction of the high friction pad 21 between the bottom of the object 50 and the vehicle seat bottom 40. The high friction pad 21 may be any type of material that is non-skid and preferably able to be rolled up or folded up for storage including material such as that used in rubberized shelf liner and bar liner for glasses.

The clamps 24A and 24B and the high friction pad 21 of the system 20 hold a container 50 or object 50 securely in an upright stationary position during transport in a vehicle and prevent it from tilting, tipping over, breaking or flying off the seat 40 in the event of a normal stop or turn. When not in use, the clamps 24A and 24B and the high friction pad 21 can be stored out of sight in the glove compartment of the vehicle for use as needed without occupying a lot of storage space.

In use, the high friction pad 21 is placed on the vehicle seat 40 and the object 50 is placed on top of the high friction pad 21. The seat belt 30A and 30B is then drawn around the object 50, with the lap belt 30B in front of the object 50 and the shoulder belt 30A behind the object 50, or visa versa. The seat belt buckle 32 is then locked securely into the seat belt locking post 31. The legs 26 or 26A of first clip 24A or 24B are placed over a segment of the seat belts 30A and 30B on a first side of the object 50. The first clip 24A or 24B is secured, thereby holding the lap belt 30B and the shoulder belt 30A at a first side of the object 50. A second clip 24A or 24B is placed over a segment of the seat belts 30A and 30B on a second side of the object 50 and is pushed towards the object 50 then fastened, which secures the lap belt 30B to the shoulder belt 30A on a second side of the object 50, thereby holding the container 50 or object 50 securely in an upright stationary position during transport on a vehicle seat 40, as shown in FIG. 1, to prevent the object 50 from tilting, tipping over, breaking or flying off the seat 40 in the event of a normal stop or turn. If desired, the seat back may be reclined slightly to prevent contact of the flowers or other objects with the seat back.

The binding clamps 24A with a spring clip tension ring 25 are used by separating the legs 26 of the clamp 24, as shown in FIG. 2, placing a segment of both the shoulder seat belt 30A and lap seat belt 30B between the legs 26, interlocking the tabs 27, and securing the locking mechanism 28, as shown in FIG. 3.

The binding clamps 24B with an enclosed end 26B, shown in FIGS. 1 and 4, are used by loosening the interlocking tabs 27A, opening the enclosed end 26B of the clamp 24B, placing a segment of both the shoulder seat belt 30A and lap seat belt 30B between the legs 26A, interlocking the tabs 27A, and securing the locking mechanism 28A.

When not in use, the clamps 24A and 24B and the high friction pad 21 can be stored out of sight in the glove compartment of the vehicle for use as needed without occupying a lot of storage space.

The flat high friction pad 21 may be manufactured in varying shapes and sizes for other uses such as crock pots, soup pots, punchbowls, casserole dishes, baking pans, aquariums, or any other container which requires being secured in a vehicle seat 40.

The object securing system 20 may be sold in a kit containing prepackaged clips or clamps 24A or 24B, a non-skid pad 21, and directions on how to use product. The prepackaged kit takes little room and can be sold beside flower arrangements or in floral display cabinets at grocery stores or florist shops.

It is understood that the preceding description is given merely by way of illustration and not in limitation of the invention and that various modifications may be made thereto without departing from the spirit of the invention as claimed.

What is claimed is:

1. An object securing system for a vehicle to bind a seat belt around an object body and maintain friction between the object base and a seat bottom of a vehicle, the system comprising in combination:
a pair of clamps for binding a shoulder seat belt and a lap seat belt of a vehicle around a body of an object with the shoulder belt on one side of the body of the object and the lap belt on an opposite side of the body of the object to secure the object from movement during transportation of the object in the vehicle with the object resting on a seat bottom of the vehicle, a first clamp of the pair of clamps binding the shoulder seat belt and the lap seat belt together adjacent to the body of the object on a first side of the object and a second clamp of the pair of clamps binding the shoulder seat belt and the lap seat belt together adjacent to the body of the object on a second side of the object opposite to the first side of the object so that the shoulder belt partially encircles the body of the object on one side of the object and the lap belt partially encircles the body of the object on an opposite side of the object with the clamps binding the belts around the body of the object and with the seat belts fastened to a seat belt lock to prevent movement of the object during transportation of the object in the vehicle, the clamps sized to fit into a glove compartment of the vehicle; and
a high friction pad placed under a bottom of the object between the object and the seat bottom of the vehicle to prevent the bottom of the object from sliding on the seat, the high friction pad sized to fit into the glove compartment of the vehicle with the pair of clamps for storage of the high friction pad and the pair of clamps when not in use.

2. The system of claim 1 wherein the pair of clamps each comprise a pair of clamp legs normally spaced apart in close proximity in parallel alignment, the pair of clamp legs being separable to admit the shoulder belt and the lap belt therebetween and further comprising a means for locking the two clamp legs together to exert a compressive force to bind together a portion of the two seat belts contacting the clamp legs.

3. The system of claim 1 wherein the high friction pad comprises a sheet of resilient flexible rubberized material which rolls up for storage.

4. The system of claim 3 wherein the high friction pad further comprises at least one uneven high friction surface to enhance the friction of the high friction pad between the bottom of the object and the vehicle seat bottom.
